(19) United States
(12) Patent Application Publication
(10) Pub. No.: US 2018/0206563 A1
(43) Pub. Date: Jul. 26, 2018

(54) GLOVE WITH MAGNETIC GRIP AID

(71) Applicants: Sukhman Singh Sandhu, Mississauga (CA); Utkrisht Saroha, Etobicoke (CA)

(72) Inventors: Sukhman Singh Sandhu, Mississauga (CA); Utkrisht Saroha, Etobicoke (CA)

(21) Appl. No.: 15/632,097

(22) Filed: Jun. 23, 2017

Related U.S. Application Data
(60) Provisional application No. 62/450,990, filed on Jan. 26, 2017.

(51) Int. Cl. A41D 19/015; A41D 19/00; A41F 1/06; H01F 7/02

(52) U.S. Cl. CPC A41D 19/01547; A41D 19/0048; H01F 7/0252; A41D 19/0013; A41D 19/002; A41F 1/06

(57) ABSTRACT

A glove for use by a human hand to grip an object, with the glove comprising a palmar portion and at least one finger stall. The palmar portion having a top palmar end adapted to be adjacent the plurality of fingers, a bottom palmar end adapted to be adjacent the wrist of the hand. The glove further comprising a cuff portion extending from the bottom palmar end opposite the at least one finger stall, with the cuff portion adapted to extend over a wrist of the hand. The glove having a magnetic member and a transfer member, wherein the transfer member has a magnetic transfer end connected with the magnetic member and a cuff transfer end connected with the cuff portion, with the magnetic member adapted to engage with the object and transfer force from the magnetic member to the cuff portion when a wearer grips an object.

This non-provisional application claims the benefit of and priority to a U.S. provisional patent application No. 62/450,990, filed on Jan. 26, 2017, the disclosure of which is hereby incorporated by reference.

### BACKGROUND

The present invention relates to a glove for the hand of a wearer to assist in participating in activities that require hand grip strength. More particularly, this invention when worn improves the wearer's ability to grip an object together with providing the hand protection from the object or other peripheral objects.

During a weight lifting routine, the primary body part in connection with a barbell or a bar is a hand of a wearer. A glove is typically used to provide cushioning, prevent calluses, and improve the grip of the wearer around the barbell, and can also be considered a fashion statement. One of the main problems the wearer experiences when using workout gloves is the loss of grip. Because current workout gloves do little to improve the grip of the wearer, weight lifters are slowly shying away from using workout gloves, and instead, feeling that there is no better alternative to the use of bare hands during workouts.

A number of workout gloves exist for improving the grip of a wearer, but only minimally. Traditional workout gloves act as a barrier between the sweat produced by the hand and the barbell being gripped. Sweat decreases the friction coefficient, which ultimately decreases the ability of the hand to maintain its grip around the barbell. However, such traditional workout gloves effectively add an extra layer of material to the barbell. As seen in the industry, there are products specifically engineered to make bars thicker. However, such products make it more difficult for the wearer to maintain a grip on the barbell. Thus, traditional workout gloves may hinder the grip of the wearer. One improvement utilized by current glove manufacturers is to decrease the thickness of the traditional workout glove. This is not optimal because it results in negating the other primary benefits of the workout glove, which are to increase cushioning and prevent calluses.

The wearer must maintain a grip for prolonged periods to effectively engage specific muscle groups in order to cause enough physiological stress to result in hypertrophy and enlargement of those specific muscle groups. The limiting factor during many pulling exercises (i.e. bent-over row, deadlift) is the hand grip. With a sustained grip, the average gym-goer may achieve a few extra repetitions within a set. When the average gym-goer participates in an exercise specifically targeting the muscles of the lower back, the hand grip might fail before the targeted muscles of the lower back have reached a hypertrophic state. As a result, exercises performed closer to the end of a workout are less effective due to hand grip fatigue rather than fatigue of the targeted muscles.

Other products besides work out gloves may be utilized by the average gym-goer. One common product is lifting straps. Lifting straps may be used in addition to a workout glove, but such lifting straps are difficult and time consuming to use, as they must be manually wrapped around the bar.

As such, there remains a need for a workout glove that improves the hand grip of a wearer during a workout concurrently with providing comfort, cushioning and substantially decreases the risk for calluses with simultaneously improving the hand grip of a wearer. Furthermore, there remains a need for a magnetic workout glove that helps transfer the force from the grip of the wearer caused by pulling on a bar during a workout to a wearer's wrist.

### BRIEF SUMMARY

A glove for use by human hand to grip an object, with the hand having a palm, dorsal side, a plurality of fingers and a thumb with respective bases secured to the palm, and a wrist. The palmar portion of the glove is adapted to cover the palm of the hand, with the palmar portion having a top palmar end adapted to be adjacent the respective bases of the plurality of fingers, a bottom palmar end adapted to be adjacent the wrist of the hand, and the at least one finger stall extending from said top palmar end to define a finger opening. The glove additionally includes a cuff portion extending from the bottom palmar end opposite the at least one finger stall, with the cuff portion adapted to extend over a wrist of the hand. The glove further includes a magnetic member and a transfer member. The transfer member has a magnetic transfer end connected with the magnetic member and a cuff transfer end connected with the cuff portion, with the magnetic member adapted to engage with the object. The glove may include a dorsal portion connected with the palmar portion to define an interior, with the dorsal portion adapted to cover the dorsal side of the hand. The dorsal portion has a top dorsal end adjacent with the top palmar end and a bottom dorsal end adjacent with the bottom palmar end. The at least one finger stall may extend from the top dorsal end and top palmar end.

Accordingly, the glove may help transfer force from the grip of the wearer caused by holding, pulling or pushing an object of ferromagnetic, paramagnetic or diamagnetic material such as a barbell during a workout to the wrist of the wearer. As a result, the glove may improve the hand grip of a wearer during a workout. Additionally, the glove may allow the wearer to increase weight being lifted during exercise by decreasing the limitation imposed by the grip strength of the wearer during the time-period the glove is utilized by the wearer.

It should be appreciated that the glove's ability to improve the hand grip simultaneously with providing comfort to the wearer allows a wide range of application possibilities such as weight lifting, CrossFit or any type of workout that challenges an individual's grip strength. In addition, it may be used by construction workers to aid in lifting objects. Furthermore, the glove may be used in military or police setting to provide a soldier or police officer with an enhanced grip on his/her weapon and/or any other equipment which may be utilized during the performance of their duties.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a glove including a magnetic member and a transfer member.

FIG. 2 illustrates a top view of the palmar portion of the glove including a channel.

FIG. 3 illustrates a top view of the palmar portion of the glove including a pocket.

FIG. 4 illustrates a side exploded view of the magnetic member within the enclosure fabric.

FIG. 5 illustrates a side exploded view of the transfer member's connection to the magnetic member via the anchor opening.

FIG. 6 illustrates a top view of the palmar portion of the glove, with the transfer member disposed within the double stitched seam, both shown in phantom.

FIG. 7 illustrates a top view of the glove, with the magnetic member including the first magnetic member, second magnetic member, third third magnetic member, and fourth magnetic member.

FIG. 8 illustrates a top view of the dorsal portion of the FIG. 7 glove embodiment.

FIG. 9 illustrates a top view of the palmar portion, with the palmar portion having a first palmar layer and a second palmar layer.

FIG. 10 illustrates a top view of the palmar portion of the glove, with the cuff portion having a flap and a hook and loop fastener.

FIG. 11 illustrates a top view of the inner dorsal side of the dorsal portion, with the glove having a transfer adjuster.

FIG. 12 illustrates a top view of the outer dorsal side of the dorsal portion, the dorsal cuff portion having a plurality of cuff fasteners.

### DETAILED DESCRIPTION

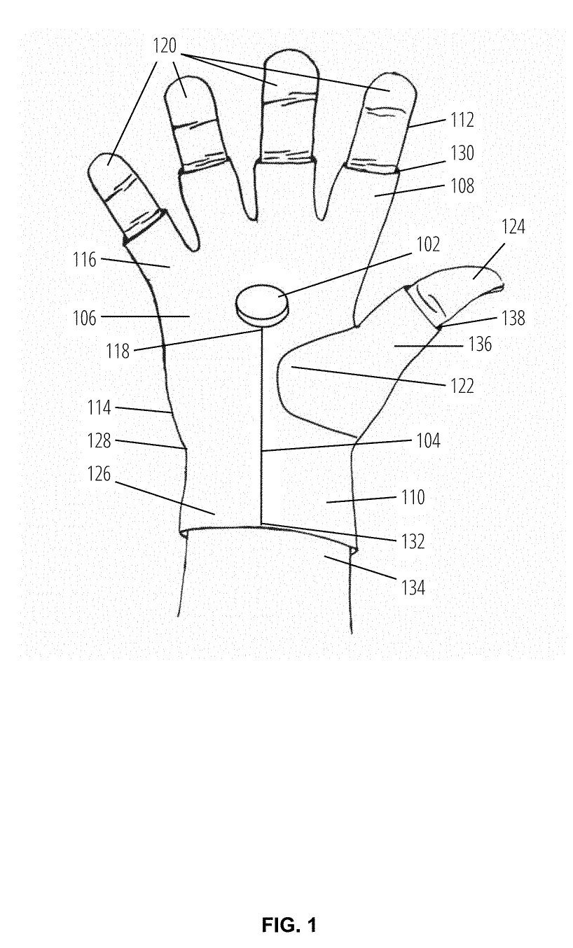

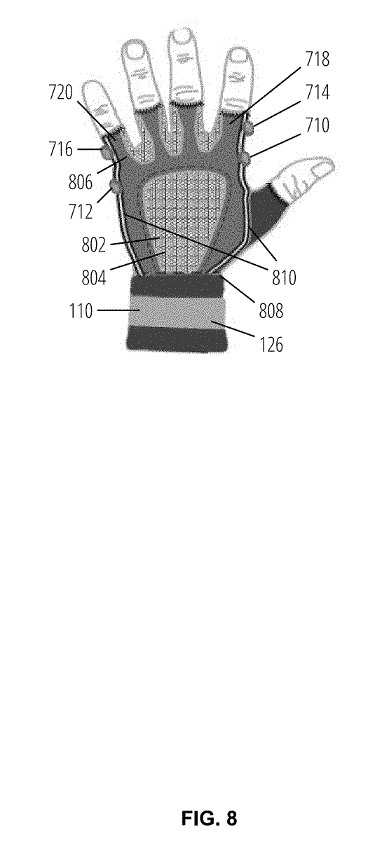

Referring to FIG. 1, illustrated generally in an embodiment of a glove 114 according to the claimed subject matter disclosed herein, with the glove 114 used for improving the grip of a hand 112 of a wearer around an object. The hand 112 of the wearer has a palm 122, a dorsal side 802, a plurality of fingers 120, a thumb 124, and a wrist 126, as indicated in FIGS. 1 and 8. Examples of various objects include, but are not limited to, dumbbells, weight-lifting bars, weight machine handles, and pull-up bars.

The glove 114 comprises a palmar portion 106, as shown in FIG. 1. The palmar portion 106 is adapted to cover the palm 122 of the hand and has a top palmar end 116 adapted to be adjacent the respective bases of the plurality of fingers 120, and a bottom palmar end 128 adapted to be adjacent the wrist 126 of the hand 112. The at least one finger stall 108 extends from the top palmar end 116 to define a finger opening 130.

The glove 114 further comprises a cuff portion 110 extending from the bottom palmar end 128 opposite the at least one finger stall 108, as shown in FIG. 1. The cuff portion 110 is adapted to extend and encircle the wrist 126 of the wearer.

Referring to FIG. 1, the glove 114 further comprises a transfer member 104 and a magnetic member 102. The transfer member 104 has a cuff transfer end 132 connected with the cuff portion 110, and a magnetic transfer end 118 connected with the magnetic member 102. In the particular embodiment illustrated in FIG. 1, the magnetic member 102 may be spaced approximately 90 millimeters from the cuff portion 110 via the transfer member 104 having a length of approximately 90 millimeters. The magnetic member 102 is adapted to engage with the object. The magnetic member 102 is attracted to objects of ferromagnetic, paramagnetic or diamagnetic material. As discussed in detail below, the transfer member 104 transfers force from the magnetic member 102 to the cuff portion 110 when the object attracts and pulls the magnetic member 102 toward itself.

In use, the transfer member 104 transfers force from the magnetic member 102 to the cuff portion 110, and to the wrist 126 of the wearer when wearer pulls on the object. This assists the wearer, as during many exercises the wearer will want to increase weight placed on the object during exercise, or resistance during a pull exercise. This can, at times, be limited to the grip strength of the wearer. The transfer member 104 may allow the wearer to increase weight during exercise, as some of the force will be transferred to the wrist 126 of the wearer.

As described above, the glove 114 assists the wearer in maintaining their grip on an object. The magnetic member 102 and the transfer member 104 are designed to engage with the object to aid the wearer in maintaining a grip and transferring a portion of the pull force produced between the engagement of the object with the magnetic member 102 to the wrist 126 of the hand 112 and forearm through the transfer member 104. This phenomenon results in dispersing some of the force from lifting the object to the wrist 126 of the hand 112 and the forearm 134, consequently decreasing the force on the muscles involved in gripping the object. Because of this phenomenon, the glove 114 may assist the wearer to increase weight during exercise due in part to the transfer of force from the palm 122 and the plurality of fingers 120 to the wrist 126 via the transfer member 104. Again, this may allow the wearer to increase the weight during exercise without the wearer having to worry about grip strength hindering the increased weight during a workout.

Referring to FIG. 8, the glove may further comprise a dorsal portion 804 connected with the palmar portion 106 of the glove 114 to define an interior. The dorsal portion 804 is adapted to cover the dorsal side 802 of the hand 112. The dorsal portion 804 has a top dorsal end 806 adjacent the top palmar end 116 and a bottom dorsal end 808 adjacent the bottom palmar end 128. In this particular embodiment, the at least one finger stall 108 stall extends from the top dorsal end 806 and top palmar end 116. In addition, the cuff portion 110 may extend from the bottom dorsal end 808 and bottom palmar end 128 in this specific embodiment and adapted to extend over the wrist 126 of the hand 112.

As shown in FIG. 1, the at least one finger stall 108 may comprise a plurality of finger stalls. In such embodiment, each of the plurality of finger stalls may receive one finger of the hand 112 of the wearer. Alternatively, in some embodiments, each finger stall may receive more than one finger of the hand 112 of the wearer. As a non-limiting example, the glove 114 may have two finger stalls for accepting two fingers of the wearer. It is to be appreciated that the glove 114 may have any number of finger stalls for accepting one or more fingers of the hand 112 of the wearer. The at least one finger stall 108 may be open so as not to cover the entire finger. The dorsal portion 804 and the palmar portion 106 may be sewn together at the periphery and between each of the at least one finger stall 108.

Continuing to refer to FIG. 1, the glove 114 may further comprise a thumb stall 136. In such embodiment, the thumb stall 136 may extend from the palmar portion 106 and dorsal portion 804 to define a thumb opening 138. The thumb opening is adapted to accept the thumb 124 of the wearer and may be open so as not to cover the entire thumb 124.

Referring to the particular embodiment of FIG. 1, the magnetic member 102 may be any suitable strength for attracting the magnetic member 102 to the object. In such embodiments, the magnetic member 102 may comprise neodymium. For example, the magnetic member 102 may have a grade of at least N30. The magnetic member 102 of the particular embodiment of FIG. 1 is circular in shape, but the magnetic member 102 should not be limited to such shape as any other shape or configuration could be implemented.

Referring to the particular embodiment of FIG. 1, the transfer member 104 extends from the magnetic member 102 to the cuff portion 110. In this embodiment, the transfer member 104 is fixed to the magnetic member 102 and the cuff portion 110 such that the transfer member 104 anchors the magnetic member 102 to the glove 114. In the embodiment of FIG. 1, the transfer member 104 is free-floating between the magnetic member 102 and the cuff portion 110. The transfer member 104 lacks a direct connection to the glove 114 except at the cuff transfer end 132 which is connected to the cuff portion 110 and magnetic transfer end 118 which is connected with the magnetic member 102. As such, the transfer member 104 is unattached to the glove 114 except at these connection points and is able to move untethered relative to the glove 114. The lack of any direct connection between the transfer member 104 and the glove 114 except between the magnetic member 102 and the cuff portion 110 allows the transfer member 104 to transfer a portion of the force of the weight of the object held by the wearer through the magnetic member 102, directly through the transfer member 104 and away from the wearer's grip (i.e. the palm 122 and plurality of fingers 120) to the wearer's wrist 126. In the event that the magnetic member 102 or transfer member 104 had a direct connection point to the glove 114 at a point other than the cuff portion 110, the force of the weight of the object held by the wearer might remain within the grasp of the wearer's gripping muscles, thereby retaining most, if not all, of the force upon a wearer's grip. As such, the free-floating magnetic member 102 and transfer member 104 permit direct transfer of a portion of force from the magnetic member 102, away from the grip and directly to the wearer's wrist 126 (i.e. the cuff transfer end 132 connected to the cuff portion 110) rather than having the magnetic member 102 and/or transfer member 104 transfer force to the palmar portion 106 of the glove 114 and correspondingly to the wearer's grip.

The transfer member 104 may comprise a cord formed from a para-aramid synthetic fiber such as Kevlar® or a synthetic leather such as Clarino™ or an equivalent. The transfer member 104 of the particular embodiment of FIG. 1 may have a width or diameter of approximately 1-5 mm.

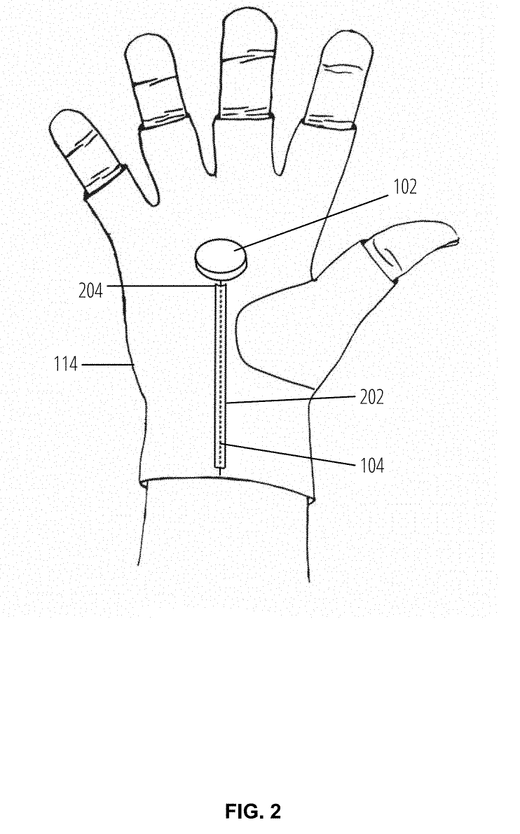

To aid in restraining the movement of the transfer member 104 in a predetermined location of the glove 114, the glove 114 of the particular embodiment of FIG. 2 further comprises a channel 202. The channel 202 may comprise a rectangular piece of fabric formed from Clarino™ cloth, which may be sewn to the glove to create a two layered compartment. The transfer member 104 may be capable of sliding within the channel 202, but the channel restricts the motion of the transfer member 104 to prevent undesirable fluctuations in the positioning of the transfer member 104. The rectangular piece of fabric may be sewn on two sides along its length in order to limit the movement of the transfer member 104 and only allow the transfer member 104 to only fluctuate in position along its length.

Referring to FIG. 2, the channel 202 of this particular embodiment of the glove 114 may comprise a magnetic channel end 204 positioned adjacent to the magnetic member's 102 desired location. The magnetic channel end 204 of this particular embodiment has an opening to allow entry of the transfer member 104. This opening of the channel is smaller than size of the magnetic member 102 so as to deny the entry of the magnetic member 102 within the channel 202. In addition, the transfer member 104 may have a first length in conjunction with the channel 202 opening's denial of the magnetic member's 102 entry in order to limit and secure the magnetic member's 102 position in a predetermined location or area.

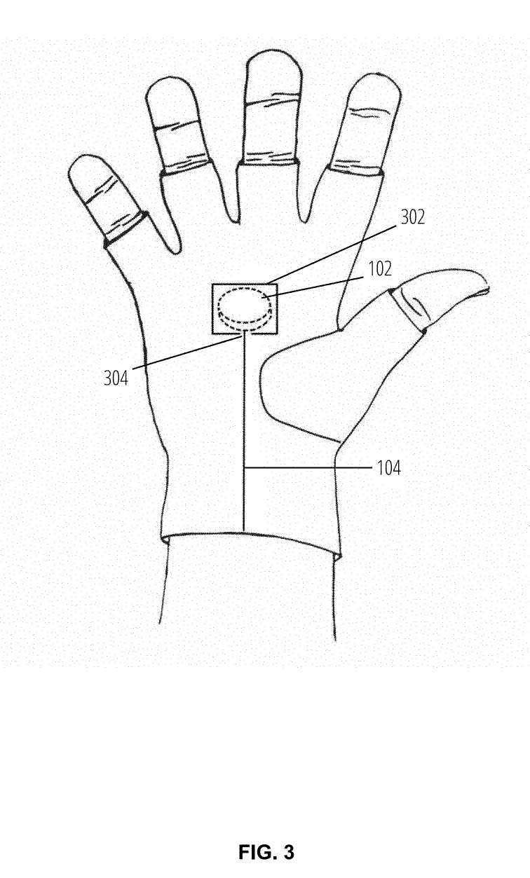

Referring specifically to FIG. 3, the magnetic member's 102 position may be secured in a predetermined location or area by the use of a pocket 302. The pocket 302 may be another layer of fabric sewn to the glove 114 in order to prevent movement of the enclosed magnetic member 102. The pocket 302 may have a pocket opening 304 to allow the transfer member 104 to travel through and connect with the magnetic member 102 disposed within the pocket 302.

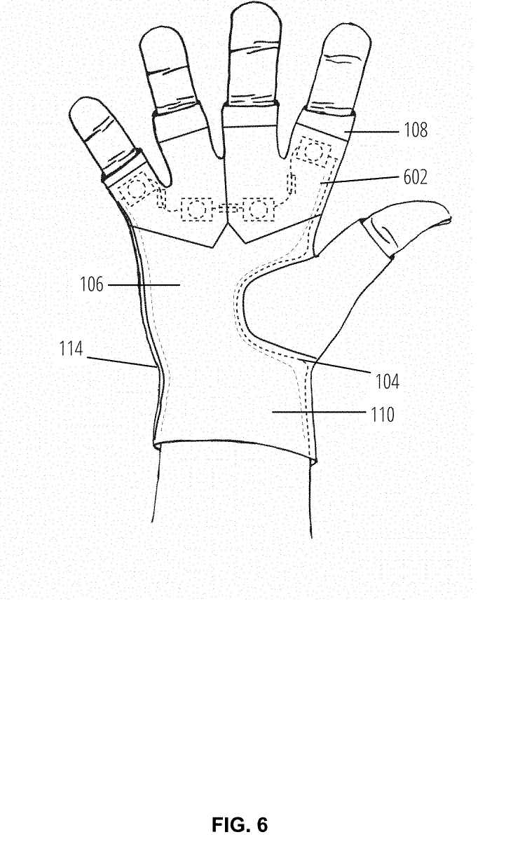

Referring specifically to FIG. 6, the channel 202 of the glove 114 may include a double stitched seam 602 connecting the palmar portion 106 and dorsal portion 804. The double stitched seam 602 may be formed from two parallel stitching that run from the at least one finger stall 108 to the cuff portion 110 to form a channel 202. In the particular embodiment of FIG. 6, the transfer member 104 is disposed within the double stitched seam 602 which may run along a side of the glove 114.

In another embodiment, as best shown in FIG. 2, the channel 202 may be formed via two layered compartment. The two layered compartment may include another layer of fabric sewn to the glove 114 along its length to limit the movement of the transfer member 104 disposed within to substantially only move along its length.

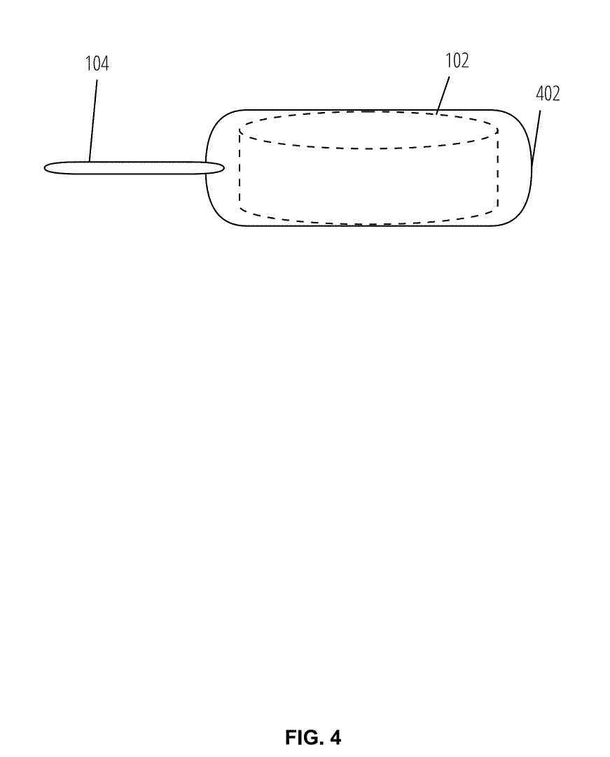

As best shown in FIG. 4, the magnetic member 102 may be wrapped in an enclosure fabric 402 to accommodate attachment with the transfer member 104 and shield the magnetic member 102 from damage. The enclosure fabric 402 may comprise a para-aramid synthetic fiber or a synthetic leather which have a greater tensile strength to withstand repeated stress and hold the magnetic member 102 in place. The magnetic member 102 may be embedded within the enclosure fabric 402 which is created by placing the magnetic member on top of a piece of fabric which is folded upon itself and the magnetic member 102 and these folds are made permanent by methods such as sewing or using an adhesive which encloses and prevents the magnetic member 102 from escaping the interior of the enclosure fabric 402. The enclosure fabric 402 may affix via stitching, adhesive or any alternative means solely to the transfer member 104 to ensure the magnetic member 102 is free-floating within the glove 114.

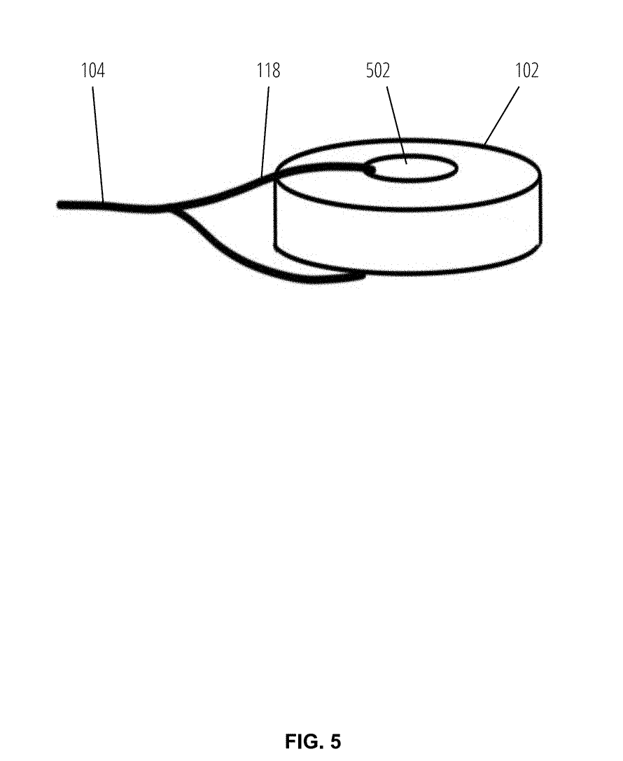

As shown in FIG. 5, the magnetic member 102 may have an anchor opening 502. In this embodiment, the anchor opening 502 is configured to receive the magnetic transfer end 118 of the transfer member 104. The transfer member 104 may pass through one side of the anchor opening 502, out the other side, and extend back to and create a knot with itself to form a loop. This attachment embodiment may eliminate the use of an enclosure fabric 402, potentially decreasing the distance and resulting in greater attraction between the magnetic member 102 and the object.

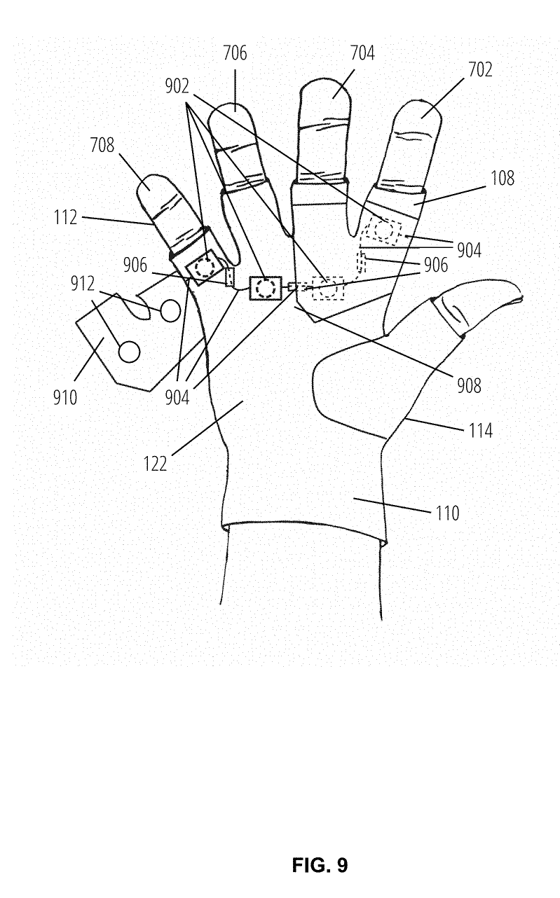

In the particular embodiment of FIG. 9, as shown in phantom, the magnetic member 102 may comprise a plurality of magnetic members 902 disposed in a spaced-apart relationship with each other and an overlaying relationship with the glove 114. The plurality of magnetic members 902 may be positioned as such: one to engage the proximal phalanx of the index finger index finger 702, one may be positioned to engage a portion of the palm 122 found below the middle finger 704 and above the proximal transverse palmar crease of the hand 112, one may be positioned to engage a portion of the palm 122 found below the ring finger 706 and above the distal transverse palmar crease, and one may be positioned to engage the proximal phalanx of the pinky finger 708 to the object. It is to be appreciated that the location and configuration of the plurality of magnetic members 902 can be modified to include any number of the plurality of magnetic members 902 that reside anywhere on the palmar portion 122, the at least one finger stall 108, or the sides of the glove 114.

The transfer member 104 in the glove 114 of the particular embodiment of FIG. 9 comprises a plurality of transfer members 904, connected with the plurality of magnetic members 902. In addition, the channel 202 in the glove of this particular embodiment may have a plurality of channels 906. As in the embodiment of FIG. 2 described above, the plurality of transfer members 904 may be capable of being retained within the plurality of channels 906 such that the plurality of transfer members 904 are free to slide within the plurality of channels 906.

Continuing to refer to the particular embodiment of FIG. 9, the palmar portion may have a first palmar layer adapted to the engage with the object, and a second palmar layer adapted to engage with the palm 122 of the hand 114. In FIG. 9, one of the two palmar layers 910 is separated from the glove 114 for an illustrative purpose only. The channel 202 may be sewn to the second palmar layer 908, as shown in FIG. 9. As an alternative, the channel may be sewn to the inner side of the first palmar layer 910. In the particular embodiment of FIG. 9, the transfer member 104 on either side of the glove 114 may connect to the cuff portion 110 by any of the methods mentioned above. The first palmar layer 910 and second palmar layer 908 may extend to cover the sides of the hand 114, with the sides being the area of the hand 114 between the palm 122 and dorsal side of the hand.

Referring to the particular embodiment of FIG. 9, the first palmar layer 910 may include at least one transfer hole 912. The at least one transfer hole 912 defines at least one transfer opening to allow the magnetic member 102 to make direct contact with the object. In this particular embodiment, direct contact may include contact between the enclosure fabric 402 of FIG. 4 and the object or contact between the magnetic member 102 and the object if enclosure fabric is absent from the glove 114.

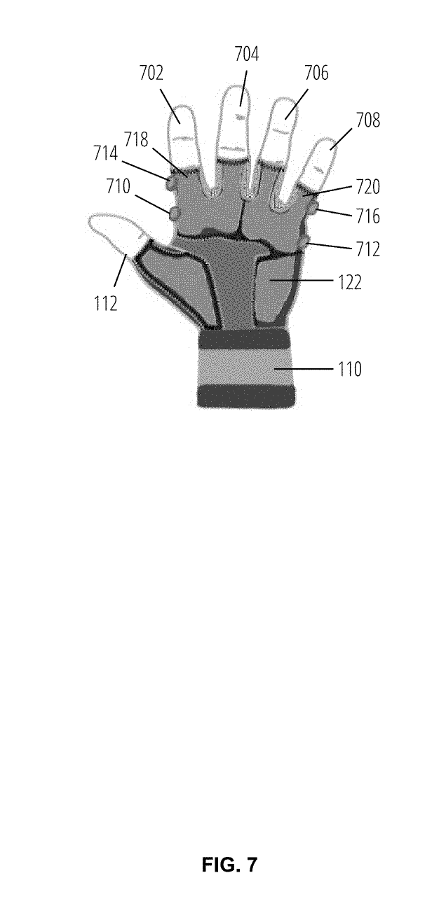

As shown in FIGS. 7 and 8, the plurality of magnetic members 902 comprise a first magnetic member 710 positioned on one side of the hand and a second magnetic member 712 positioned on the opposite side of the hand 112 between the palm 122 and dorsal side 802 of the hand 112. The at least one finger stall 108 in the particular embodiment of FIGS. 7 and 8 has an index finger stall 718 and a pinky finger stall 720. The plurality of magnetic members 902 may further have a third magnetic member 714 and a fourth magnetic member 716. The third magnetic member 714 is located on a portion of the index finger stall 718 adapted to cover a portion of the outer side of the index finger 702 and spaced above the first magnetic member 710 in relation to the cuff portion 110. The fourth magnetic member 716 is located on a portion of the pinky finger stall 720 adapted to cover a portion of the outer side of the pinky finger 708 and spaced above the second magnetic member 712 in relation to the cuff portion 110. By having the magnetic member 102 on the side of the hand 112, it may decrease or eliminate there is any discomfort that may arise with having a solid inflexible magnetic member compressed between the wearer's hand 112 and the object. In addition, the particular embodiment in FIGS. 7 and 8 may result in an increased lifespan and durability of the magnetic member due to the magnetic member not experiencing the compressive force mentioned above. The described benefit of positioning the magnetic member 102 on the side of the hand 112 when using a magnetic member 102 that is inflexible and solid is an example benefit and should not limit the magnetic member 102 to such physical properties. For example, a flexible magnetic member 102 may be implemented.

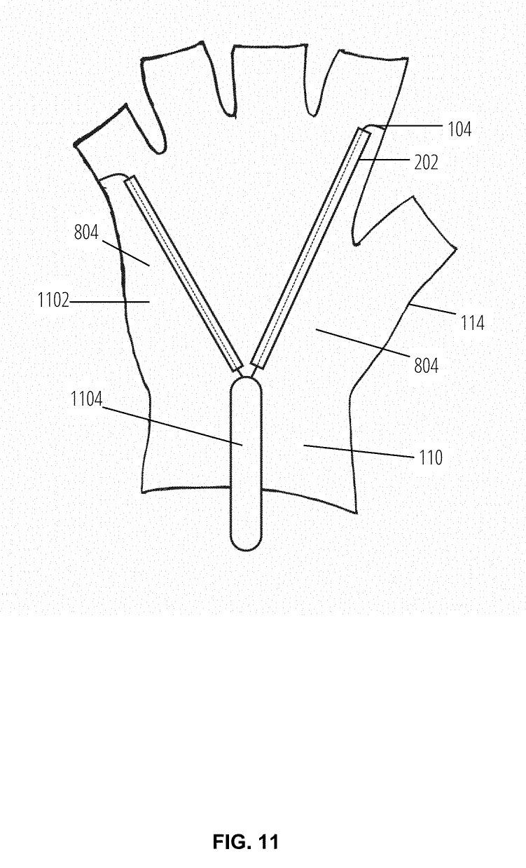

Referring now to FIG. 11, the transfer member 104 may extend across the dorsal portion 804 of the glove 114. The transfer member 104 may travel through the dorsal portion 804 in an overlaying relationship and the cuff transfer end 132 may connect with the cuff portion 110 adjacent the dorsal portion 804.

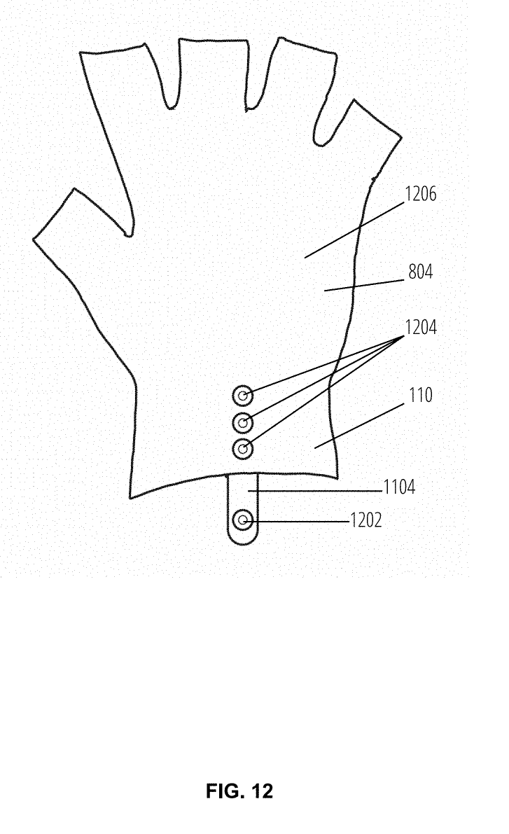

In addition, the cuff transfer end 132 of the transfer member 104 of the glove 114 may have a transfer adjuster 1104. The transfer adjuster 1104 includes a transfer fastener 1202 and the cuff portion 110 includes a plurality of cuff fasteners 1204. When the wearer pulls on the transfer adjuster 1104 adjacent the cuff portion 110, the wearer may fasten the transfer fastener 1202 to any of the cuff fasteners 1204 to achieve a desired fit of the glove 114 on the hand 112. The transfer member 104 may be adjusted via mechanical fasteners such as, but not limited to, snap fastener (as illustrated in FIG. 12), hook and loop fastener or magnet. When the wearer pulls on the transfer adjuster 1104, the transfer member 104 is also pulled with the transfer adjuster 1104, which then pulls the magnetic member 102, allowing the adjustment of the transfer member 104. This may assist a wearer to adjust the tightness of the transfer member 104 in order fine-tune the magnetic member's 102 positioning and to tailor suitable fitting and comfort of the glove 114 on the hand 112. One example of this embodiment is illustrated in FIGS. 11 and 12, wherein the dorsal portion 804 may further comprise an inner dorsal side 1102 and an outer dorsal side 1206. The transfer member 104 travels overlaying the inner dorsal side 1102, connects with the transfer adjuster 1104, the transfer adjustor 1104 wraps around the bottom end of the cuff portion 110 to secure to one of the plurality of cuff fasteners 1204 which are located on the outer dorsal side 1206.

The palmar portion 122 and the dorsal portion 804 may be made of polyester and spandex or elastane. The first palmar layer 910 may be fabricated from Clarino® leather or equivalent. Typically, the first palmar layer 910, second palmar layer 908 and dorsal portion 804 are sewn together. It is to be appreciated that the material used for the glove 114 may comprise any material suitable to wear as a glove 114 for a hand 112.

During the gripping of an object, such as a barbell, the spatial relationship between the plurality of fingers 120 and the palm 122 may be important. In order to maintain grip, the plurality of fingers 120 must remain curled towards the palm 122. Straightening of the plurality of fingers 120 to any degree may be considered a decrease in grip. To remedy this phenomenon, the plurality of magnetic members 902 may be strategically spaced apart. In the particular embodiment of FIGS. 7 and 8, the first magnetic member 710 and second magnetic member 712 may decrease the strength or energy required by the wearer to maintain the position of the palm 122 on the object while the third magnetic member 714 and fourth magnetic member 716 may decrease the strength or energy required to maintain the position of the plurality of the fingers 120 on the object. This may be referred to as the grip locking mechanism, the name illustrating that the positioning of the plurality of magnetic members 902 in strategic positions such as the positioning found in the particular embodiment of FIGS. 7 and 8 may aid in maintaining a strong grip position.

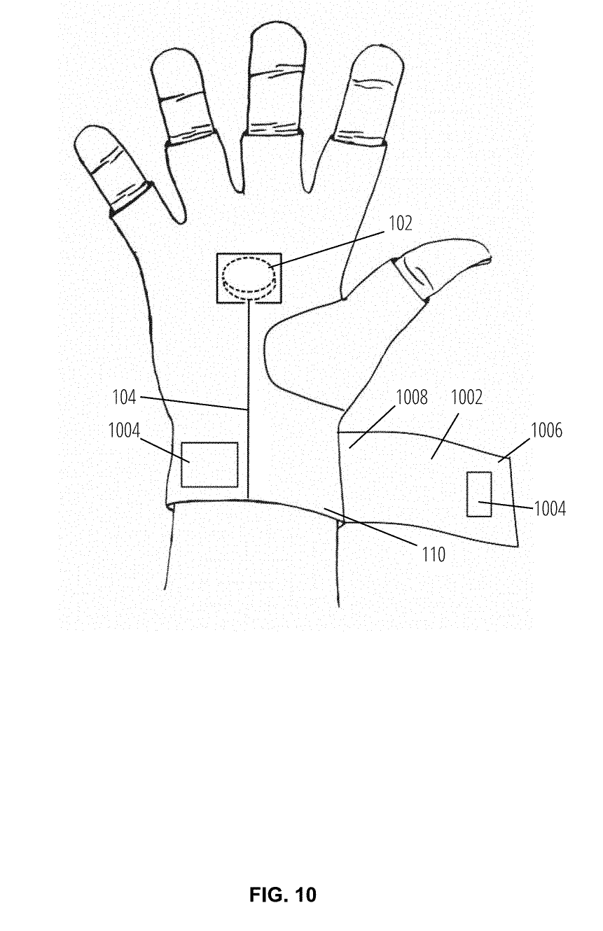

The glove 114, as shown in FIG. 10, may include a flap 1002 having a fixed end 1008 connected with the cuff portion 110, and a free end 1006 connectable with the cuff portion 110 for tightening the cuff portion 110 around the wrist 126 of the wearer. The flap 1002 allows the wearer to tighten the cuff portion 110 to a desired tightness around the wrist 126. The glove 114 may include a hook and loop fastener 1004 on the free end 1006 and the cuff portion 110. An example of the hook and loop fastener is Velcro®.

The magnetic member 102 may be an electromagnet. The electromagnet may include a wire forming a solenoid adapted to receive an electrical current. The electromagnet may include a ferromagnetic core, with the wire wrapped around the ferromagnetic core. A battery may be included to power the electromagnet.

The magnetic member 102 is located such that it does not cause undue pain to the wearer by creating localized points of pressure against the palm 122 of the hand 112 of the wearer when using the glove 114. Having the magnetic member 102 not directly attached or affixed to the palmar portion 106 or at least one finger stall of the glove 114 allows the magnetic member 102 to move unsynchronized from the palmar portion 106 and at least one finger stall 108 to more effectively transfer force from the magnetic member 102 to the cuff portion 110. If the magnetic member 102 is not free floating, the magnetic member 102 would pull on the stitching or adhesive that fixes the magnetic member 102 to the palmar portion 106 or at least one finger stall 108, which would make the force pull on the portion of the glove 114 that the magnetic member 102 connected to. The free-floating characteristic of the magnetic member 102 allows the transfer of force from the magnetic member 102 to the wrist 126 of the wearer.

The magnetic member 102 may have a first polarity adapted to be engageable with the magnetic member 102 of a second glove having a second polarity from the first polarity of the glove 114. In a particular embodiment, the plurality of magnetic members 902 may have a polarity adapted to be engageable with the plurality of magnetic members 902 of a second glove having opposite polarity from the polarity of the plurality of magnetic members 902 of the glove 114. This allows the gloves to mate together when not in use to reduce the chance of losing either glove.

The description above does not limit the transferring of force to the cuff portion 110 only. As long as one of the plurality of transfer members 810 connects with the cuff portion 110, the remaining are free to connect to other areas of the glove 114. As best shown in FIG. 8, the first magnetic member 710 may connect to the cuff portion 110 and the third magnetic member 714 via a plurality of transfer members 810, the second magnetic member 712 may connect to the cuff portion 110 and the fourth magnetic member 716 via the plurality of transfer members 810, the third magnetic member 714 may connect to the first magnetic member 710 and the index finger stall 718 via the plurality of transfer members 810, and the fourth magnetic member 716 may connect to the second magnetic member 712 and the pinky finger stall 720.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A glove for use by a human hand to grip an object, with the hand having a palm, dorsal side, a plurality of fingers and a thumb with respective bases secured to the palm, and a wrist, said glove comprising:
A palmar portion and at least one finger stall;
Wherein the palmar portion is adapted to cover the palm of the hand, with said palmar portion having a top palmar end adapted to be adjacent the respective bases of the plurality of fingers, a bottom palmar end adapted to be adjacent the wrist end of the hand, and the at least one finger stall extending from said top palmar end to define a finger opening;
A cuff portion extending from said bottom palmar end opposite said at least one finger stall, with said cuff portion adapted to extend over a wrist of the hand;
a magnetic member;
a transfer member;
wherein said transfer member has a magnetic transfer end connected with said magnetic member and a cuff transfer end connected with said cuff portion, with said magnetic member adapted to engage with the object.

2. The glove as set forth in claim 1, further comprising a dorsal portion connected with said palmar portion to define an interior, with said dorsal portion adapted to cover the dorsal side of the hand, said dorsal portion having a top dorsal end adjacent with said top palmar end, and a bottom dorsal end adjacent with said bottom palmar end, and the at least one finger stall extending from said top dorsal end and said top palmar end.

3. The glove as set forth in claim 2, wherein the cuff portion extends from said bottom dorsal end and said bottom palmar end opposite said at least one finger stall, with said cuff portion adapted to extend over the wrist of the hand.

4. The glove as set forth in claim 1, further comprising a thumb stall, said thumb stall extends from said palmar portion and said dorsal portion to define a thumb opening.

5. The glove as set forth in claim 1, wherein said magnetic member comprises neodymium.

6. The glove as set forth in claim 5, wherein said magnetic member has a grade of at least N30.

7. The glove as set forth in claim 1, wherein said transfer member is a synthetic leather.

8. The glove as set forth in claim 1, wherein said transfer member is a para-aramid synthetic fiber.

9. The glove as set forth in claim 1, wherein said magnetic member is secured to a location spaced from said cuff portion on the glove, said transfer member disposed within a channel, the channel having a magnetic channel end located adjacent to the magnetic member location and having an opening to allow entry of said transfer member, the opening of said channel is smaller than size of said magnetic member so as to deny entry of magnetic member within said channel, and said transfer member having a first length to limit movement of said magnetic member.

10. The glove as set forth in claim 9, wherein the channel is formed via a double stitched seam.

11. The glove as set forth in claim 9, wherein the channel is formed via a two layered compartment to limit the movement of said transfer member disposed within.

12. The glove as set forth in claim 1, wherein said magnetic member is disposed within a pocket, said pocket having a pocket opening to allow travel of said transfer member.

13. The glove as set forth in claim 1, wherein said palmar portion comprising a first palmar layer adapted to engage with the object, and a second palmar layer adapted to engage with the palm of the hand, with said magnetic member disposed within said first and second palmar layers.

14. The glove as set forth in claim 13, wherein said first palmar layer and said second palmar layer cover the sides of the hand between the palm and the dorsal side of the hand.

15. The glove as set forth in claim 13, wherein said first palmar layer having at least one transfer hole defining at least one transfer opening to allow said magnetic member to make direct contact with the object.

16. The glove as set forth in claim 1, wherein said magnetic member is wrapped in an enclosure fabric for accommodating attachment with said transfer member.

17. The glove as set forth in claim 16, wherein said enclosure fabric is attached to said transfer member via stitching.

18. The glove as set forth in claim 16, wherein said enclosure fabric is made of said synthetic leather.

19. The glove as set forth in claim 1, wherein said magnetic member having an anchor opening configured to receive said magnetic transfer end of said transfer member, said transfer member passing through said opening to directly anchor with said magnetic member.

20. The glove as set forth in claim 1, further comprising a flap having a fixed end connected with said cuff portion, and a free end connectable with said cuff portion for tightening said cuff portion to the wrist.

21. The glove as set forth in claim 20, further comprising a hook and loop fastener on said free end of said flap and said cuff portion.

22. The glove as set forth in claim 2, wherein said transfer member extends across said dorsal portion of said glove in an overlaying relationship with said dorsal portion.

23. The glove as set forth in claim 3, wherein said cuff transfer end of said transfer member is connected with cuff portion adjacent said dorsal portion.

24. The glove as set forth in claim 1, wherein said magnetic member is an electromagnet.

25. The glove as set forth in claim 1, wherein said cuff portion is adapted to encircle portion of a forearm corresponding to the hand.

26. The glove as set forth in claim 1, wherein the magnetic member has a first polarity, with said magnetic member adapted to be engageable with the magnetic member of a second glove having a second polarity which is opposite to said first polarity of said magnetic member.

27. The glove as set forth in claim 1, wherein said magnetic member comprises a plurality of magnetic members disposed in a spaced-apart relationship with each other and in an overlaying relationship with said glove, and said transfer member comprising a plurality of transfer members, each of the plurality of magnetic members adapted to be engageable with said object.

28. The glove as set forth in claim 27, wherein the plurality of magnetic members having a first magnetic member and a second magnetic member, said first magnetic member positioned to cover portion of side of the hand located between said palm and dorsal side, and the second magnetic member positioned on the opposite side of the hand in relation to the first magnetic member.

29. The glove as set forth in claim 28, wherein the at least one finger stall having an index finger stall and a pinky finger stall, the plurality of magnetic members having a third magnetic member and a fourth magnetic member, said third magnetic member positioned on the outer side of the index finger stall spaced above said first magnetic member in relation to said cuff portion, and the fourth magnetic member positioned on the outside side of the pinky finger stall spaced above said second magnetic member in relation to said cuff portion.

30. The glove as set forth in claim 1, further comprising a plurality of cuff fasteners, and wherein the cuff transfer end of said transfer member having a transfer adjuster, the plurality of cuff fasteners connected to a portion of said cuff portion, and the transfer adjuster having a transfer fastener connectable with any of the plurality of cuff fasteners.
